(19) United States
(12) Patent Application Publication
(10) Pub. No.: US 2008/0310695 A1
(43) Pub. Date: Dec. 18, 2008

(54) Locally Adaptive Nonlinear Noise Reduction

(76) Inventors: Stephen J. Garnier, Chesterland, OH (US); Wayne R. Dannels, Mentor, OH (US); Deepak Bhat, Bedford Heights, OH (US)

Correspondence Address: PHILIPS INTELLECTUAL PROPERTY & STANDARDS, 595 MINER ROAD, CLEVELAND, OH, 44143, US

(21) Appl. No.: 10/570,083

(22) PCT Filed: Aug. 30, 2004
(86) PCT No.: PCT/IB04/28343

§ 371 Date: Mar. 1, 2006

Related U.S. Application Data
(60) Provisional application No. 60/500,209, filed on Sep. 4, 2003.

(51) Int. Cl. G06K 9/00

(52) U.S. Cl. 382/131

(57) ABSTRACT

An imaging scanner (10) acquires imaging data. A reconstruction processor (30) reconstructs the imaging data into an unfiltered reconstructed image. A local noise mapping processor (64, 120, 136, 140, 142, 152) generates a noise map (68, 68′, 68″) representative of spatially varying noise characteristics in the unfiltered reconstructed image. A locally adaptive non linear noise filter (60) differently filters different regions of the unfiltered reconstructed image in accordance with the noise map (68, 68′, 68″) to produce a filtered reconstructed image.

The following relates to the imaging arts. It finds particular application in sensitivity encoded magnetic resonance imaging, and will be described with particular reference thereto. However, it also finds application in other types of magnetic resonance imaging, as well as in transmission computed tomography (CJ), single photon emission computed tomography (SPECT), positron emission tomography (PET), and other imaging modalities.

In many imaging methods, raw data is acquired in a format that is not readily construed as an image. In magnetic resonance imaging, for example, imaging data is typically acquired as k-space data samples, while in tomographic imaging the data is typically acquired as one-dimensional or two-dimensional projections. A reconstruction processor processes the raw data to produce a reconstructed image of the imaging subject. For magnetic resonance imaging, the k-space data samples are spatially encoded by resonance frequency and phase, and the reconstruction processor commonly employs a two-dimensional Fourier transform to convert resonance measurements into a spatial image. Filtered backprojection is typically employed to reconstruct projection data.

The acquired raw data typically has a generally spatially uniform and typically Gaussian noise profile. In conventional magnetic resonance imaging, for example, the k-space data samples are acquired in resonance frequency encoded lines, each line with a single amount of phase encoding. The phase encoding is stepped to acquire data from line to line. The acquired k-space data has substantially uniform Gaussian noise characteristics which are largely independent of signal intensity. The conventional Fourier transform-based reconstruction does not substantially affect this Gaussian noise distribution, and so the resulting reconstructed image has spatially uniform noise variance that is independent of the local image intensity. Spatially uniform noise is advantageous in that it does not usually aggregate into apparent structural features, and therefore does not present a substantial risk of misinterpretation.

This advantageous noise uniformity can be lost, however, when more complex image reconstruction methods or hardware are employed. For example, in SENSES encoding and other types of sensitivity encoding, resonance data are collected concurrently by a plurality of receive coils with different sensitivity profiles. In one technique, the outputs of the coils are combined to synthesize a number of k-space data lines. In the SENSES technique, the outputs of each coil are reconstructed separately to create a plurality of folded images that are commensurate in number to the number of coils. The folded images, from data acquired concurrently by the plurality of radio frequency receive coils with different coil sensitivity profiles, are combined in an unfolding process to recover the skipped k-space lines and produce an unfolded reconstructed image. The unfolding process weighs the image elements by spatially varying coil sensitivity factors, which causes the unfolded reconstructed image to have a spatially non-uniform noise variance distribution. The noise non-uniformities can aggregate to form apparent image features that can mislead a radiologist or other interpreter.

Another magnetic resonance imaging method that can introduce spatial noise non-uniformities is constant level appearance processing (sometimes referred to as CLEAR). In this method, a single coil or a phased array of coils acquires imaging data that is Fourier-transformed into a reconstructed image that has signal intensity non-uniformity due to spatial variations in coil sensitivity. The constant level appearance processing locally adjusts image intensities to account for spatially non-uniform coil sensitivity. This local adjusting introduces local variations in the noise.

As yet another example, techniques which sample k-space non-uniformly, such as in spiral magnetic resonance imaging, can introduce spatially variant noise non-uniformities. In spiral magnetic resonance imaging, a spiral k-space trajectory is followed, rather than the more conventional k-space grid data acquisition. As a result, the conventional two-dimensional Fourier transform reconstruction is not readily applied. Reconstruction of spiral k-space trajectories typically involves varying amounts of interpolation, rebinning or other processing that can introduce non-uniform noise distributions in the reconstructed image.

Noise reduction filters have been developed which employ methods such as graduated non-convexity, variable conductance diffusion, anisotropic diffusion, biased anisotropic diffusion, mean field annealing, and the like. These noise filtering methods typically uniformly reduce the noise variance throughout the image, but do not address spatially non-uniform noise variances. Thus, these noise reduction filters do not smooth out local areas of enhanced noise to a desirable nearly uniform noise level throughout the image, and that nonuniform noise can confuse or mislead a radiologist or other image interpreter.

The present invention contemplates an improved apparatus and method that overcomes the aforementioned limitations and others.

According to one aspect, an imaging system is disclosed. A means is provided for acquiring imaging data. A means is provided for reconstructing the imaging data into an unfiltered reconstructed image. A means is provided for generating a noise map representative of spatially varying noise characteristics in the unfiltered reconstructed image. A means is provided for differently filtering different regions of the unfiltered reconstructed image in accordance with the noise map to produce a filtered reconstructed image.

According to another aspect, an imaging method is provided. Imaging data is acquired. The imaging data is reconstructed into an unfiltered reconstructed image. A noise gain map is generated that is representative of spatially varying noise characteristics in the unfiltered reconstructed image. Different regions of the unfiltered reconstructed image are filtered differently in accordance with the noise map to produce a filtered reconstructed image.

According to yet another aspect, an imaging method is provided. Imaging data is acquired. The imaging data is reconstructed into an unfiltered reconstructed image. A spatially varying signal-to-noise ratio map is constructed corresponding to the unfiltered reconstructed image. The unfiltered reconstructed image is filtered based on the spatially varying signal-to-noise ratio map to produce a filtered reconstructed image.

One advantage resides in compensating for locally varying noise levels.

Another advantage resides in performing noise filtering in a manner which recognizes and utilizes information pertaining to spatial noise variance distribution extracted from analysis of the image reconstruction process or from empirical measurements.

Yet another advantage resides in providing a general-purpose locally adaptive non-linear noise reduction filter that is applicable for filtering substantially any type of noise variance distribution.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

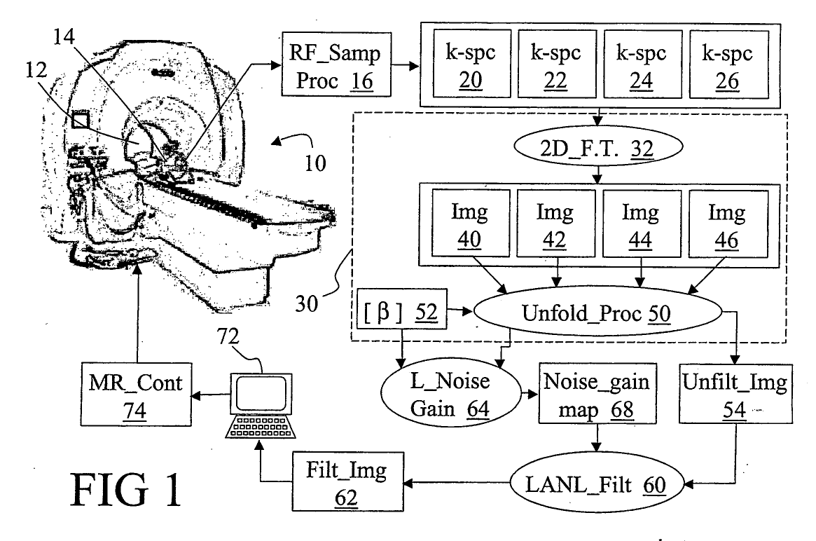

FIG. 1 diagrammatically shows a magnetic resonance imaging system including a four-channel magnetic resonance receive coil for imaging with sensitivity-encoding, and further including a locally adaptive non-linear noise reduction filter.

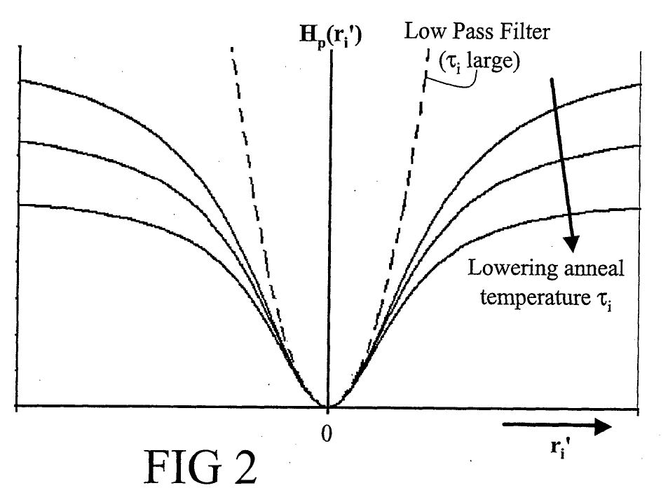

FIG. 2 illustrates an exemplary prior component of the locally adaptive non-linear noise reduction filter of FIG. 1.

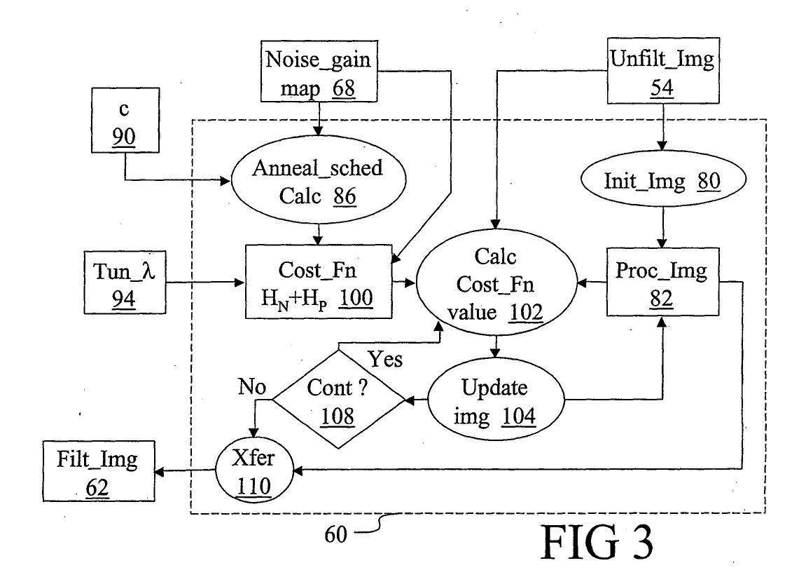

FIG. 3 diagrammatically shows the locally adaptive non-linear noise reduction filter of the magnetic resonance imaging system of FIG. 1. Although shown as a component of the magnetic resonance imaging system of FIG. 1, the noise reduction filter of FIG. 2 is a general-purpose noise filter that is usable for filtering images acquired using substantially any type of imaging modality.

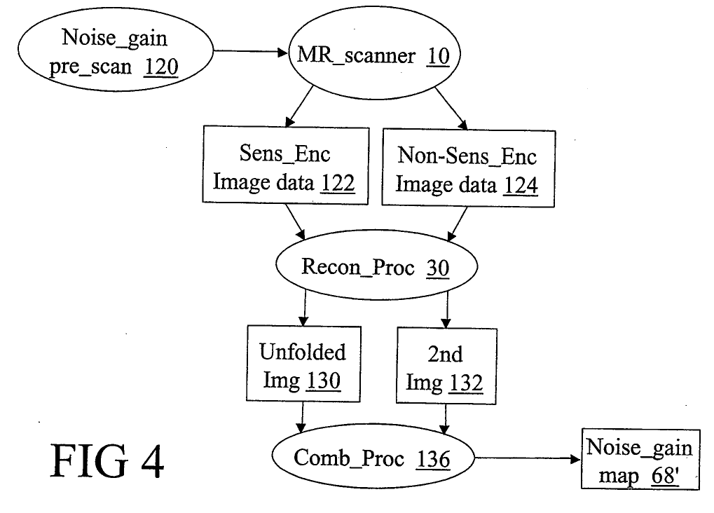

FIG. 4 diagrammatically shows an apparatus for empirically extracting a noise gain map usable in the noise reduction filter of FIG. 3 for filtering images acquired using sensitivity encoded magnetic resonance imaging.

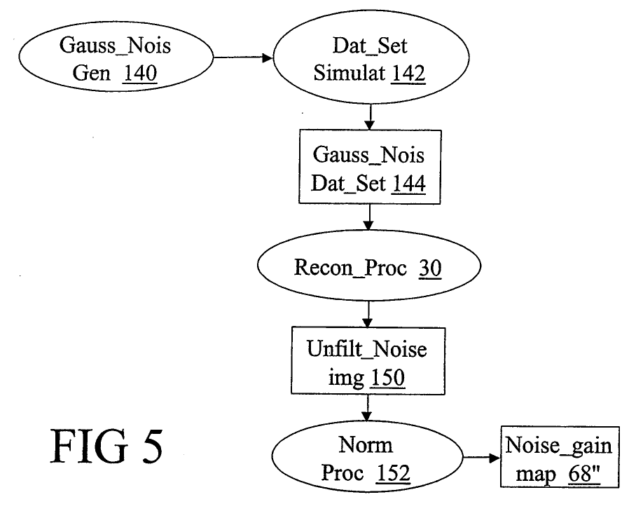

FIG. 5 diagrammatically shows a general-purpose apparatus for empirically extracting a noise gain map usable in the noise reduction filter of FIG. 3 for filtering images acquired using substantially any type of imaging modality.

With reference to FIG. 1, a magnetic resonance imaging system includes a magnetic resonance imaging scanner 10, which in the exemplary embodiment is an Intera 3.0T short-bore, high-field (3.0T) magnetic resonance imaging scanner available from Philips Corporation. However, substantially any magnetic resonance imaging scanner can be used that includes a main magnet, magnetic field gradient coils for providing magnetic field gradients, and a radio frequency transmitter for exciting nuclear magnetic resonances in an imaging subject. The Intera 3.0T is advantageously configured to provide whole-body imaging; however, scanners that image smaller fields of view can also be employed, as well as scanners that provide lower main magnetic fields and/or have a longer bore or an open bore. Moreover, the locally adaptive non-linear noise filtering described herein is generally applicable to imaging modalities other than magnetic resonance imaging.

The magnetic resonance imaging scanner 10 provides a constant main magnetic field in an axial direction within an examination region 12. In a typical magnetic resonance imaging sequence implemented by the scanner 10, a single slice or a multi-slice, volumetric slab select gradient is applied in a slice-select direction. When the slice select direction is parallel to the axial direction, it defines a slice or slab orthogonal to the axial direction. While the slice-select gradient is extant, a radio frequency excitation pulse or pulse packet is transmitted into the examination region 12 of the scanner 10 to excite magnetic resonance in the defined slice or slab of an imaging subject that is selected by the slice-select gradient. Some time after removal of the radio frequency excitation and the slice-select gradient, a phase encode magnetic field gradient is applied along a phase encode direction that is generally transverse to the slice-select gradient direction. In slab imaging, a second phase encode gradient is applied in a direction that is parallel to the slice- or slab-select direction. The phase encode gradient or gradients encode the magnetic resonance of the excited slice or slab in the phase encode direction or directions. Some time after removal of the phase encode magnetic field gradient, a read magnetic field gradient profile is applied in a readout direction that is generally transverse to the phase encode and slice-select directions. During application of the read magnetic field gradient profile, magnetic resonance samples are acquired in the readout direction. Of course, these directions can be rotated or exchanged, and need not be orthogonal. Typically, the magnetic resonance imaging sequence applies a succession of alternating phase encode gradients and read gradients that cycle the magnetic resonance sampling through k-space.

The described magnetic resonance imaging sequence is exemplary only. Those skilled in the art can readily modify the described sequence to comport with specific applications. The sequence optionally includes other features, such as one or more 180° inversion pulses, one or more magnetic resonance spoiler gradients, and so forth. The magnetic resonance imaging sequence can also implement spiral sampling in which a spiral trajectory of k-space is followed, or can implement another imaging technique.

In the following, a sensitivity encoding (SENSE) imaging application is described. However, the locally adaptive non-linear noise filtering described herein is not limited to SENSE, but is generally applicable to other imaging techniques that introduce spatial noise non-uniformities, such as constant level appearance (CLEAR) processing, spiral imaging, and so forth. Moreover, the filtering is not limited to magnetic resonance imaging applications, but rather also finds application in tomographic imaging and in other imaging modalities. Although described in reference to a two-dimensional slice for simplicity of illustration, it is to be appreciated that the described techniques are also applicable to three-dimensional imaging or higher dimensions, such as time, imaging.

To implement SENSE imaging, the magnetic resonance imaging scanner 10 includes a multiple-coil receive coil array 14 which in the exemplary embodiment includes four receive coils. Other numbers of receive coils can be employed; for example, a sensitivity encoding (SENSE) head coil that includes eight receive coils combined and multiplexed onto 6 receive channels is available from Philips Corporation. During application of the read magnetic field gradient profile, a sampling circuit 16 reads the four channels of the multiple-receive coil array 14 to acquire magnetic resonance samples concurrently of the same spatial region of the examination region 12. The acquired magnetic resonance samples are stored in k-space memories 20, 22, 24, 26 that correspond to the four receive coils of the receive coils array 14. A reconstruction processor 30 includes a two-dimensional fast Fourier transform processor 32 that processes the magnetic resonance samples of each of the four k-space memories 20, 22, 24, 26, to generate four corresponding folded reconstructed images that are stored in folded image memories 40, 42, 44, 46.

In sensitivity encoding using the exemplary four-channel coil array 14, only one-fourth of the k-space lines are read. For example, if a 256 phase encode line image is to be reconstructed, the sensitivity encoded imaging applies only 64 read gradients to generate data lines at 64 phase encode steps. The sensitivity parameters of the coils are designed such that as each coil reads with a different spatial sensitivity pattern, the outputs themselves or combinations thereof effectively create data corresponding to 256 phase encode steps, in a rectangular encoding scheme. A SENSE unfolding processor 50 combines and unfolds the folded reconstructed images based on coil sensitivity parameters [β] 52 of the receive coils to compute an unfiltered reconstructed image 54. The coil sensitivity parameters of the sensitivities matrix [β] 52 indicate the spatial sensitivities of the coils of the four-channel coil array 14, and are typically empirically measured for the coil array 14. Optionally, a variable density sensitivity encoding is used, in which the phase encode lines are distributed non-uniformly in k-space with a largest density of phase encode lines near the center of k-space.

Typically, the noise of the imaging data stored in each k-space memory 20, 22, 24, 26 has a uniform Gaussian distribution, and the Fourier transform processor 32 does not distort this uniform Gaussian distribution. Hence, the folded reconstructed images stored in the folded image memories 40, 42, 44, 46 typically have substantially uniform, Gaussian noise distributions. Because the coils have different sensitivity characteristics, as the gain is adjusted and equalized the noise characteristics of the images being combined are also adjusted, and tend to become more different. More specifically, as the unfolding processor 50 applies the coil sensitivity parameters 52 to combine and unfold the folded reconstructed images, different voxels, pixels, or otherwise-identified image elements of the unfiltered reconstructed image 54 have different gain values applied. As a result, the previously uniform Gaussian noise distribution is locally distorted or otherwise altered to produce a spatially non-uniform noise distribution in the unfiltered reconstructed image 54.

To address this problem, a locally adaptive non-linear noise filter 60 performs noise-reducing filtering of the unfiltered reconstructed image 54 to produce a filtered reconstructed image 62. The filter 60 takes advantage of known information about noise non-uniformity introduced by the reconstruction process. In the case of sensitivity encoding, information about noise non-uniformity is suitably extracted from the coil sensitivities matrix 52 by a local noise gain processor 64 to compute a noise gain map 68 that contains information on the locally varying noise variance introduced by the reconstruction processor 30. The noise filter 60 receives the unfiltered reconstructed image 54, which contains information on the image signal with noise superimposed thereupon, along with the noise gain map 68 that contains information on the noise gain introduced by the reconstruction processor 30. The noise filter 60 therefore has information sufficient to compute a substantially accurate signal-to-noise ratio map indicative of the local signal-to-noise ratio across the unfiltered reconstructed image 54. Based on this signal and noise information, the noise filter 60 performs a locally adaptive, iterative non-linear optimization to reduce the overall noise and to substantially reduce fluctuations in noise variance across the image.

A user interface 72 receives the filtered reconstructed image 62 and performs suitable image processing to produce a human viewable display image that is displayed on a display monitor of the user interface 72. For example, a two-dimensional slice or a three-dimensional rendering can be produced and displayed. Alternatively or in addition, the filtered reconstructed image 62 can be printed on paper, stored electronically, transmitted over a local area network or over the Internet, or otherwise processed. The user interface 72 preferably also enables a radiologist or other operator to communicate with a magnetic resonance imaging sequence controller 74 to control the magnetic resonance imaging scanner 10 to generate magnetic resonance sequences, modify magnetic resonance sequences, execute magnetic resonance sequences, or otherwise operate the imaging scanner 10.

The magnetic resonance imaging system described with reference to FIG. 1 is also suitable for performing imaging with constant level appearance (CLEAR) processing. In CLEAR, imaging k-space data is acquired by the magnetic resonance imaging scanner 10 without sensitivity encoding, and the k-space data are processed by the two-dimensional Fourier transform processor 32. The unfolding processor 50 is then applied with a SENSE factor of unity to compensate for spatial coil sensitivity non-uniformities, to produce the unfiltered reconstructed image 54. As in sensitivity encoding, CLEAR processing employs the coil sensitivities matrix 52 and introduces spatial non-uniformities into the noise variance distribution of the CLEAR-processed image. The noise filter 60 filters the noise non-uniformities introduced by the CLEAR processing using the noise gain map 68 which is computed from the coil sensitivities matrix 52, or which is obtained in another manner.

A preferred embodiment of the locally adaptive non-linear noise filter 60 is based on Bayes' rule:

$${\prod }_{i} P ( {r}_{i} / {d}_{i} ) \cdot P ( {d}_{i} ) = {\prod }_{i} P ( {d}_{i} / {r}_{i} ) \cdot P ( {r}_{i} ) , \qquad ( 1 )$$

where: i indexes the pixels, voxels, or other image elements of the images; dᵢ are image elements of the data being filtered, that is, the unfiltered reconstructed image 54; rᵢ are image elements of the restoration, that is, the filtered reconstructed image 62; P(dᵢ) is the probability of the image element dᵢ, which is a constant for given unfiltered reconstructed image 54; P(rᵢ) is some a priori probability of the restoration image element rᵢ; P(dᵢ/rᵢ) is the probability of the input data image element dᵢ for a given corresponding restoration image element rᵢ; and P(rᵢ/dᵢ) is the probability of the restoration image element rᵢ for a corresponding given input data image element dᵢ. Rearranging Equation (1), the filtered reconstructed image 62 is made up of restoration image elements rᵢ that maximize:

$${\prod }_{i} P ( {r}_{i} / {d}_{i} ) = \frac{{\prod }_{i} P ( {d}_{i} / {r}_{i} ) \cdot P ( {r}_{i} )}{{\prod }_{i} P ( {d}_{i} )} . \qquad ( 2 )$$

Recognizing that P(dᵢ) is a constant for the given unfiltered reconstructed image 54, Equation (2) is suitably processed by taking a negative logarithm of both sides to convert the product to a summation according to:

$${\sum }_{i} - ln ( P ( {r}_{i} / {d}_{i} ) ) = {\sum }_{i} - ln ( P ( {d}_{i} / {r}_{i} ) ) + {\sum }_{i} - ln ( P ( {r}_{i} ) ) , \qquad ( 3 )$$

where the constant denominator has been dropped. Equation (3) can be rewritten as a cost function or objective function H according to:

$$\begin{matrix}H = {H}_{N} + {H}_{P} , \\ where & ( 4 ) \\ {H}_{N} = {\sum }_{i} - ln ( P ( {d}_{i} / {r}_{i} ) ) = {\sum }_{i} \frac{{( {r}_{i} - {d}_{i} )}^{2}}{2 {g}_{i} {σ}^{2}} , \\ and & ( 5 ) \\ {H}_{P} = {\sum }_{i} - ln ( P ( {r}_{i} ) ) = {\sum }_{i} {\sum }_{η} \frac{{λ ( \frac{\partial {r}_{i}}{\partial {x}_{η}} )}^{2}}{4 {σ}^{2} + \frac{λ}{{τ}_{i}} {( \frac{\partial {r}_{i}}{\partial {x}_{η}} )}^{2}} . & ( 6 )\end{matrix}$$

In the rightmost side of Equation (5), a Gaussian noise distribution is assumed with a standard deviation σ. A non-uniform noise variance across the image is accounted for by an image element-dependent gain gᵢ that is generally different for each image element i. Since the difference (rᵢ−dᵢ)² generally has a variance corresponding to the local noise at image element i, division by the noise gain gᵢ advantageously substantially normalizes the noise term H_{N} over the range of noise gains gᵢ of the noise gain map 68. The cost function component H_{N} provides a maximum likelihood component or noise component of the overall cost function H. H_{N} enforces fidelity of the filtered reconstructed image 62 to the unfiltered reconstructed image 54.

H_{P} as set forth in Equation (6) is based on a priori knowledge that the underlying image is piecewise smooth. More generally, the term H_{P} reflects an additional model or criterion or goal, such as the goal of favoring images which are more piecewise smooth, or a term in a function associated with meeting such a criterion. The term H_{P} is referred to herein as the prior term or prior component of the cost function H. The rightmost side of Equation (6) expresses an expected piecewise smoothness of the restored image. A large prior component H_{P} tends to provide filtering in accordance with an expected piecewise smooth nature of the underlying image, albeit with degraded edge preservation. The parameter η in Equation (6) indicates a direction in the image, and the piecewise smoothness is evaluated over several directions indicated by summation over η. The parameter λ is a scaling or tuning parameter indicative of a global gain of the reconstruction processor 30. The parameter τᵢ is called an annealing temperature herein, and is used to control the nonlinear contribution to the cost function H of the prior term H_{P}. Over an image with varying noise statistics, the annealing temperature τᵢ generally depends upon the local noise statistics at image element i.

It is appreciated that the directions x_{η} are not restricted to directions within a two-dimensional image. Rather, they optionally also include one or more directions in a third spatial dimension to provide filtering of a volume image representation. The directions x_{η} are more generally viewed as dimensions, and can include for example a temporal dimension. The dimensions x_{η} can still further include variations in a parameter such as the variation of an external stimulus to the patient, or variations in an imaging data acquisition parameter which spans a series of values in successive acquisitions.

With reference to FIG. 2, the prior term H_{P}(rᵢ′) of Equation (3) (where rᵢ′=∂rᵢ/∂x_{η}) is plotted for a range of annealing temperatures τᵢ. For high annealing temperature, H_{P} tends toward a low pass filter (indicated by dashed lines in FIG. 2). As the annealing temperature τᵢ decreases, the prior term H_{P} smoothly decreases toward an amplitude-reduced nonlinear form, with larger decreases at larger rᵢ′ values. Since a large derivative rᵢ′ is indicative of an edge or other sharp transition in the image, a lowered annealing temperature τᵢ provides a reduced prior component H_{P}, so that the least squares or maximum likelihood component H_{N} of the filter H dominates to preserve edges while maintaining fidelity to the data. In contrast, a high τᵢ produces a large prior term H_{P} that dominates over the least squares term. A large prior term H_{P} provides less edge preservation and can produce increased image blurring.

With reference to FIG. 3, a preferred embodiment of the locally adaptive non-linear noise filter 60 iteratively adjusts the restoration image elements rᵢ to minimize the objective or cost function H of Equation (4). An initialization processor 80 suitably initializes the iterative process by loading the unfiltered image 54 into a processing image memory 82. An annealing schedule processor 86 constructs the initial or final temperatures of an annealing schedule by computing image element-dependent annealing temperatures τᵢ. A suitable initial or final annealing temperature is given by:

$${τ}_{i} = \sqrt{\frac{c}{{g}_{i}}} , \qquad ( 7 )$$

where c 90 is a global constant across the image and the noise gain gᵢ imports local noise information from the noise gain map 64 into the spatially varying initial or final annealing temperature. The annealing schedule is produced by multiplying all τᵢ by an arbitrary constant (global for the entire image) at the conclusion of each minimization of H. This is equivalent to varying the value of c within Equation (7). The initial or final annealing temperature of Equation (7) is exemplary only. In general, a preferred initial or final annealing temperature typically corresponds approximately inversely to the overall gain λgᵢ. That is, as the overall gain λgᵢ increases, a smaller final annealing temperature τᵢ is appropriate.

The constructed annealing schedule, along with the noise gain map 64 and tuning constant λ 94, are used to construct the objective or cost function H 100 which corresponds to Equation (4). In a preferred embodiment the components H_{N} and H_{P} are given by Equations (5) and (6), respectively; however, those skilled in the art can modify H_{N} and H_{P} to suit specific applications. In particular, the prior component H_{P} is readily adapted to urge the restoration toward selected expected image characteristics.

A processor 102 computes the cost function value for inputs including the restoration processing image iteration stored in the processing image memory 82 and the unfiltered reconstructed image 54. The image elements rᵢ of the processing image are adjusted based on the cost function H using an update processor 104 that employs a conjugate gradient descent algorithm or other suitable optimization algorithm, and the updated restoration image is stored in the processing image memory 82. The cost function value processor 102 and the update image processor 104 iteratively adjust the restoration image to minimize the cost function H. After each iteration, a stopping criteria processor 108 determines whether or not selected iteration stopping criteria are met. Such selected stopping criteria can include, for example, stopping when a maximum percentage parameter change between iterations decreases below an iteration improvement threshold, stopping when a maximum derivative ∂H/∂rᵢ decreases below a slope threshold, or so forth. When the stopping criteria processor 108 indicates that the stopping criteria are satisfied, a transfer processor 110 is invoked to transfer the processing image stored in the processing image memory 82 into the filtered image memory 62.

The global tuning inputs c and λ can be selected in various ways. In one contemplated embodiment, these values are preset for the given sensitivity encoding magnetic resonance imaging scanner 10 and coils array 14, so that the radiologist or other operator is provided with locally adaptive non-linear noise filtering that is transparent to the operator. In another contemplated embodiment, the noise filter 60 steps through a range of several values for one or more global inputs producing an iteratively optimized filtered reconstructed image for each value, and the several filtered reconstructed images are displayed to the radiologist or other operator for manual selection of a preferred restoration. The global noise standard deviation σ of Equations (5) and (6) is preferably computed in the first instance based on noise variance averaged or otherwise statistically processed over the unfiltered reconstructed image 54; however, it is also contemplated to make σ a global tuning parameter that is adjusted to optimize the restoration. Moreover, it is further contemplated to modify the image element-dependent annealing schedule of Equation (7) for specific imaging applications. Still further, those skilled in the art can readily modify the prior component H_{P} of Equation (7) to incorporate another expected image characteristic rather than the exemplary piecewise smooth image characteristic.

One advantage of iterating the optimization, and iterating over a series of annealing values, is that the resulting processed image may be driven to a global optimum, as opposed to converging towards a local minimum of the cost function.

Those skilled in the art will appreciate the advantageous incorporation of the noise gain map 68 into the noise filter 60 to provide locally adaptive filtering that accounts for a spatially non-uniform noise variance distribution. With reference to FIG. 1, in the exemplary sensitivity encoding magnetic resonance imaging embodiment, the noise gain map 68 is readily computed by the local noise gain processor 64 from the coil sensitivities factors matrix [β] 52. The unfolding process is described by D=[β]R where vector D contains sensitivity encoded or folded reconstructed image element values and vector R contains image element values of the unfolded reconstructed image. Solving for the unfolded image elements vector R involves taking the generalized inverse of the sensitivity coils matrix [β]. Since the sensitivity coils matrix [β] is in general a non-square matrix which may be ill-conditioned, a pseudo-inverse of the matrix [β] is preferably computed by least squares optimization and matrix regularization to produce R=[K]D where [K] is the pseudo-inverse of [β]. The generalized inverse matrix [K] contains the non-uniform weightings applied to the image elements during unfolding. The noise gain gᵢ is given by:

$${g}_{i} = {\vert {g}_{p} \vert}^{2} = {\sum }_{j} {\vert {k}_{i , j} \vert}^{2} , \qquad ( 8 )$$

where k_{i,j} are elements of the pseudo-inverse matrix [K] corresponding to the ith unfolded image element. For conventional SENSE, the parameter gₚ corresponds to the Pruessman SENSE gain parameters known in the art for the specific case of conventional SENSE imaging; however, the right-most side of Equation (8) is more general, and is readily adapted to computing noise gain maps for variable density sensitivity encoding, constant level appearance processing, and other techniques that employ intensity scaling based on image element-dependent coil sensitivity factors.

Equation (8) provides a method for obtaining the noise gain map 68 based on analysis of the unfolding or constant level appearance processing. A similar analysis of the reconstruction can be performed for other reconstruction processes, such as spiral magnetic resonance imaging reconstruction processes, three-dimensional helical computed tomography reconstruction processes, or the like, to obtain a suitable noise gain map for applying the filter 60. Indeed, the noise filter 60 is generally applicable whenever a reasonable estimate of the spatially varying noise gain is obtainable, even if the noise variations are introduced by a source other than the reconstruction. For example, the noise gain map 68 can incorporate apriori known variations in the noise variance in the as-acquired raw imaging data, that is, noise variance non-uniformities present in the data prior to the image reconstruction process.

With returning reference to FIG. 1 and with further reference to FIG. 4, another method for obtaining a noise gain map 681 for sensitivity encoding is described. A noise gain pre-scan 120 executed by the magnetic resonance imaging scanner 10 performs imaging with and without sensitivity encoding to generate sensitivity encoded imaging data 122 and imaging data without sensitivity encoding 124, respectively. The reconstruction processor 30 reconstructs the sensitivity encoded image data set 122 to produce a corresponding unfolded reconstructed image 130. The reconstruction processor 30 also reconstructs the non-sensitivity encoded image data set 124 to produce a second reconstructed image 132. The reconstructed images 130, 132 differ in that the unfolded reconstructed image 130 includes spatially non-uniform noise introduced by the unfolding, while the second reconstructed image 132, which was processed only by the Fourier transform processor 32 of FIG. 1, has substantially spatially uniform noise. A combining processor 136 performs image subtraction and suitable normalization to extract the spatial noise variation of the unfolded reconstructed image 130 as the noise gain map 68′, which is optionally substituted for the analytically computed noise gain map 68 of FIG. 1.

With continuing reference to FIG. 1 and with further reference to FIG. 5, yet another method for obtaining a noise gain map 68″ is described. In this approach, a Gaussian noise generator 140 is accessed by a data set simulator 142 to simulate a Gaussian noise magnetic resonance imaging data set 144 consisting of spatially uniform Gaussian noise superimposed on a spatially uniform signal level, which may be a zero signal level. The Gaussian noise data set 144 is processed by the reconstruction processor 30 in its usual operating mode to generate an unfiltered noise image 150. For example, the Gaussian noise data set 144 can simulate a sensitivity encoded magnetic resonance imaging data set, in which case the unfiltered noise image 150 is an unfolded reconstructed image.

Since the input data set had a spatially uniform signal level and spatially uniform Gaussian noise, spatially non-uniform noise variance in the unfiltered noise image 150 is attributable to noise gain introduced by the reconstruction processor 30. A normalization processor 152 suitably normalizes the unfiltered noise image 150, for example to remove the constant signal level on which the Gaussian noise was superimposed, to generate the noise gain map 68″ which is optionally substituted for the analytically computed noise gain map 68 of FIG. 1. The process shown in FIG. 5 for obtaining the noise gain map is not limited to sensitivity encoded magnetic resonance imaging, and is furthermore not limited to magnetic resonance imaging in general. Rather, the process shown in FIG. 5 is generally applicable for measuring a noise gain map associated with substantially any image reconstruction process regardless of the type of imaging modality.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. An imaging system including:
an imaging means for acquiring imaging data;
a reconstructing means for reconstructing the imaging data into an unfiltered reconstructed image;
a noise mapping means for generating a noise map representative of spatially varying noise characteristics in the unfiltered reconstructed image; and
a filtering means for differently filtering different regions of the unfiltered reconstructed image in accordance with the noise map to produce a filtered reconstructed image.

2. The imaging system as set forth in claim 1, wherein the noise map is representative of spatially varying noise characteristics generated by the reconstructing means, the noise mapping means including:
a means for generating a Gaussian noise data set, the Gaussian noise data set being inputted into the reconstructing means to generate an unfiltered noise image; and
a means for estimating the noise map based on the unfiltered noise image.

3. The imaging system as set forth in claim 1, wherein the imaging means includes a magnetic resonance imaging scanner with a plurality of radio frequency receive coils for acquiring sensitivity-encoded imaging data, and the noise mapping means includes:
a means for invoking the imaging means and the reconstructing means to:
measure sensitivity encoded first imaging data and reconstruct said first imaging data into an unfolded reconstructed image, and
measure second imaging data that is not sensitivity encoded and reconstruct said second imaging data into a second image; and
a combining means for combining the first and second reconstructed images to generate the noise map.

4. The imaging system as set forth in claim 1, wherein the imaging means includes a magnetic resonance imaging scanner with a plurality of radio frequency receive coils for acquiring sensitivity-encoded imaging data, the reconstructing means includes an unfolding processor that employs a sensitivity matrix corresponding to the plurality of radio frequency receive coils, and the noise mapping means includes:
an unfolding noise computation means for computing the noise map from the sensitivities matrix.

5. The imaging system as set forth in claim 4, wherein the reconstructing means further includes:
a two-dimensional Fourier transform processor for computing a folded reconstructed images corresponding to image data collected by each radio frequency receive coil, the unfolding processor combining the folded reconstructed images to generate the unfiltered reconstructed image.

6. The imaging system as set forth in claim 4, wherein the unfolding noise computation means obtains a generalized inverse of the sensitivities matrix and derives the noise map from the generalized inverse.

7. The imaging system as set forth in claim 1, wherein the imaging means includes a magnetic resonance imaging scanner, the reconstructing means includes a constant level appearance processor that applies coil sensitivity information to perform a homogeneity correction of the unfiltered reconstructed image, and the noise mapping means includes:
a constant level appearance gain computation means for computing the noise map based on the applied coil sensitivity information.

8. The imaging system as set forth in claim 1, wherein the filtering means includes:
a means for computing a cost function having a local gain selected based on the noise map; and
an optimization processor that iteratively adjusts a processing image to minimize the cost function, the optimized processing image corresponding to the filtered reconstructed image.

9. The imaging system as set forth in claim 1, wherein the filtering means includes:
a means for computing a non-linear cost function incorporating the noise map; and
a means for iteratively adjusting a processing image to minimize the cost function.

10. An imaging method including:
acquiring imaging data;
reconstructing the imaging data into an unfiltered reconstructed image;
generating a noise map representative of spatially varying noise characteristics in the unfiltered reconstructed image; and
filtering different regions of the unfiltered reconstructed image differently in accordance with the noise map to produce a filtered reconstructed image.

11. The imaging method as set forth in claim 10, wherein:
the acquiring of imaging data includes measuring sensitivity encoded magnetic resonance imaging data using a plurality of radio frequency receive coils;
the reconstructing of the imaging data includes:
Fourier transforming imaging data acquired by each radio frequency receive coil to generate a folded image corresponding to that radio frequency receive coil, and
unfolding the folded images to generate the unfiltered reconstructed image; and
the generating of the noise map includes obtaining a spatially dependent noise amplification introduced during the unfolding.

12. The imaging method as set forth in claim 10, wherein:
the acquiring of imaging data includes acquiring magnetic resonance imaging data;
the reconstructing of the imaging data includes:
computing a Fourier transform-based reconstruction of the acquired magnetic resonance imaging data, and
locally adjusting the Fourier transform-based reconstruction to correct for a spatially varying sensitivity of the acquiring; and
the generating of the noise map includes computing a spatially varying noise gain introduced by the local adjusting of the Fourier transform-based reconstruction.

13. The imaging method as set forth in claim 10, wherein the reconstructing of the imaging data introduces at least a portion of the spatially varying noise characteristics into the unfiltered reconstructed image, and the generating of the noise map includes:
computing a spatially varying noise gain generated by the reconstructing, the noise map corresponding to the computed spatially varying noise gain.

14. The imaging method as set forth in claim 10, wherein the reconstructing of the imaging data introduces at least a portion of the spatially varying noise characteristics into the unfiltered reconstructed image, and the generating of the noise map includes:
measuring a spatially varying noise gain generated by the reconstructing, the noise map corresponding to the measured spatially varying noise gain.

15. The imaging method as set forth in claim 10, wherein the filtering includes:
computing an objective function including a noise component indicative of fidelity of a processing image to the unfiltered reconstructed image and a prior component indicative of closeness of the processing image to an expected image characteristic; and
iteratively adjusting the processing image to optimize the objective function.

16. The imaging method as set forth in claim 15, wherein the computing of the noise component of the objective function includes:
for each image element, computing a least squares difference between the processing image element and the unfiltered reconstructed image element; and
normalizing the least squares difference for each image element by a corresponding element of the noise map.

17. The imaging method as set forth in claim 15, wherein the computing of the noise component of the objective function includes computing a function H_{N} in accordance with:
$${H}_{n} ∝ {\sum }_{i} {( \frac{{d}_{i} - {r}_{i}}{{Ag}_{i}} )}^{2}$$
where i sums over the image elements of the unfiltered reconstructed image, dᵢ is indicative of the ith element of the unfiltered reconstructed image, rᵢ is indicative of the ith element of the processing image, A is a scaling constant, and gᵢ is computed based on an element of the noise map corresponding to the ith element of the unfiltered reconstructed image.

18. The imaging method as set forth in claim 15, wherein the expected image characteristic of the prior component of the objective function includes an expected piecewise smooth image characteristic, the expected piecewise smooth image characteristic being locally dependent upon a corresponding local value of the noise map.

19. The imaging method as set forth in claim 15, wherein the computing of the prior component of the objective function includes computing a function H_{P} in accordance with:
$${H}_{P} ∝ {\sum }_{i} {\sum }_{η} \frac{{A ( \frac{\partial {r}_{i}}{\partial {x}_{η}} )}^{2}}{B + \frac{C}{{τ}_{i}} {( \frac{\partial {r}_{i}}{\partial {x}_{η}} )}^{2}}$$
where i sums over the image elements of the unfiltered reconstructed image, η sums over at least one direction in the unfiltered reconstructed image, x_{η} indicates the ηth direction, rᵢ is indicative of the ith element of the processing image, A, B and C are constants, and τᵢ is computed based on an element of the noise map corresponding to the ith element of the unfiltered reconstructed image.

20. The imaging method as set forth in claim 15, wherein the computing of the prior component of the objective function includes:
scaling a function of a spatial derivative of the processing image by a linear combination of a constant noise term and a spatially varying annealing term.

21. The imaging method as set forth in claim 15, wherein the computing of the prior component of the objective function includes:
constructing the prior component as a function of a spatial derivative of the processing image and as a function of an annealing parameter, such that the prior component smoothly spans a range between a generally low pass filter form and a nonlinear form for a range of values of the annealing parameter.

22. An imaging method including:
acquiring imaging data;
reconstructing the imaging data into an unfiltered reconstructed image;
constructing a spatially varying signal-to-noise ratio map corresponding to the unfiltered reconstructed image; and
filtering of the unfiltered reconstructed image based on the spatially varying signal-to-noise ratio map to produce a filtered reconstructed image.

23. The imaging method as set forth in claim 22, wherein:
the acquiring includes acquiring magnetic resonance imaging data using at least one radio frequency receive coil;
the reconstructing includes adjusting the unfiltered reconstructed image based on a spatially varying sensitivity of the at least one radio frequency receive coil; and
the constructing of a spatially varying signal-to-noise ratio map includes mapping spatially varying changes in signal-to-noise ratio introduced by the adjusting.

24. The imaging method as set forth in claim 23, wherein the at least one radio frequency receive coil includes at least two radio frequency receive coils, the acquiring includes acquiring sensitivity encoded magnetic resonance imaging data, and the adjusting of the unfiltered reconstructed image includes:
combining the sensitivity encoded imaging data acquired by the at least two radio frequency receive coils to generate the unfiltered reconstructed image as an unfolded image.
